(19) United States
(12) Patent Application Publication
(10) Pub. No.: US 2008/0242139 A1
(43) Pub. Date: Oct. 2, 2008

(54) Connector and Line Connecting Method Thereof

(76) Inventor: Hiroyuki Matsuoka, Kanagawa (JP)

Correspondence Address: 3M INNOVATIVE PROPERTIES COMPANY, PO BOX 33427, ST. PAUL, MN, 55133-3427, US

(21) Appl. No.: 10/599,245

(22) PCT Filed: Mar. 14, 2005
(86) PCT No.: PCT/US05/08559

§ 371 Date: Sep. 22, 2006

(30) Foreign Application Priority Data
Apr. 1, 2004 (JP) 2004-108998

(51) Int. Cl. H01R 13/627; H01R 13/52

(52) U.S. Cl. 439/357; 439/271

(57) ABSTRACT

To reduce as much as possible an outer size of a connector having an insulation-displacement type wire connection structure without deteriorating stability and reliability of connection between terminal elements and conductors. A connector (20) includes a plurality of terminal elements each having insulation-displacement type conductor-connecting sections (14) to be connected to a wire conductor and a contact section brought into electric contact with corresponding terminal elements of a counterpart connector and an electrically insulating body (20) for exposing the individual contact sections and supporting the terminal elements (12). The body (20) comprises a first support member (22) for supporting the terminal elements (12) and a second support member (24) for supporting a plurality of wires W. The first support member (22) has a fitting portion (26) for positioning the coTo reduce as much as possible an outer size of a connector having an insulation-displacement type wire connection structure without deteriorating stability and reliability of connection between terminal elements and conductors. A connector (20) includes a plurality of terminal elements each insulation-displacement type conductor-connecting sections (14) to be connected to a wire conductor and a contact section brought into electric contact with corresponding terminal elements of a counterpart connector and electrically insulating body (20) for exposing the individual contact sections and supporting the terminal elements (12). The body (20) comprises a first support (22) for supporting the terminal elements (12) and second support member (24) for supporting a plurality of wires W, the first support member (22) has a fitting portion (26) for positioning the contact sections (18) of the terminal elements (12) to the corresponding terminal elements of the counterpart connector and fitting them to the connection counter connector. The conductor-connecting section and the contact section of each terminal element (1) are aligned and arranged in a direction intersecting a connector fitting direction defined by the fitting portion (26).

### TECHNICAL FIELD

The present invention relates to a connector having an insulation-displacement type wire connection structure. The present invention also relates to a line connecting method in a connector having an insulation-displacement type wire connection structure.

### BACKGROUND ART

A mutual connection structure between a terminal element and a wire conductor in a connector includes a structure (so-called “crimp structure”) in which a conductor-connecting section is allowed to undergo elastic deformation (that is, caulking) and is connected to a conductor exposed by removing a sheath of a wire end in a predetermined length, and a structure (so-called “insulation-displacement structure”) in which a slit having a smaller width than a conductor diameter is formed in a conductor-connecting section of a terminal element into a sharp outer shape and the conductor-connecting section is pierced to a sheath (or an insulator) of a wire so as to press-fit a conductor into the slit. Furthermore, connectors having various wire connection structures of a conductor contact type in which a conductor exposed by removing a sheath at a wire end in a predetermined length is brought into pressure contact with a conductor-connecting section of a terminal element have been proposed as connectors that can cope relatively easily with the reduction of a diameter of a wire conductor satisfying a required level of high-density connection and with a narrower pitch of a terminal element arrangement required in recent years (refer to Patent References 1 and 2, for example).

The connector described in Patent Reference 1 can be adapted to a flat coaxial cable and includes a plurality of terminal elements each having a conductor-connecting section connected to a cable conductor, an electrical insulator for supporting the terminal elements while the individual conductor-connecting sections are exposed and a plurality of contact members assembled to the body, for individually bringing the cable conductors under pressure into pressure contact with the conductor-connecting sections of the terminal elements. In this connector, a conductor-connecting section having a bent outer edge is provided to each of the terminal elements (base contacts) while a contact surface having a bent shape corresponding to the bent outer edge of the conductor-connecting section of each terminal element is provided to each of a plurality of contact members (support contacts) formed of a conductive metal plate in the same way as the terminal elements. A body for arranging and supporting the terminal elements in a predetermined spaced-apart arrangement and an electrically insulating cover for arranging and supporting a plurality of contact members in a corresponding spaced-apart arrangement are assembled to each other in a direction intersecting a cable extension direction while the cables as connection object are arranged between them. In consequence, the conductors of the cables are forcedly extended along an outer edge of the conductor-connecting section of the terminal element and a curve shape of the contact surface of the contact member and are fixedly clamped under pressure.

The connector disclosed in Patent Reference 2 is a flat-cable connector for connecting a flat cable to a printed board and includes a plurality of terminal elements each having a conductor-connecting section to be connected to a cable conductor, an electrically insulating body for exposing individual conductor-connecting sections and supporting the terminal elements and a contact member for bringing under pressure the cable conductors into contact with the conductor-connecting sections of the terminal elements. A conductor-connecting section of a cantilever beam type is provided to each of the terminal elements, and while corresponding conductors are brought into contact with these conductor-connecting sections, the flat cable is put on the terminal elements. When a contact member (push plate) formed of one metal sheet is brought into contact under this state with an outer surface (grounding surface) of the flat cable and is fitted to the body while the connector-connecting sections of the terminals are pushed, the individual terminal elements undergo flexible deflection and the corresponding conductors of the flat cable are connected under pressure to these conductor-connecting sections.

Incidentally, in an ordinary structure, each terminal element of the connector has a contact section electrically connected to the corresponding terminal element of a counterpart connector, and the insulating body of the connector has a fitting portion that exposes and arranges the contact sections of the terminal elements, positions their contact sections to the corresponding terminal elements and fits them to the counterpart connector. The connector of Patent Reference 1 is constituted in such a fashion that a connector fitting direction defined by the fitting section of the body (that is, a connector moving direction for appropriately fitting the fitting section to the complementary fitting portion of the counterpart connector) is substantially parallel to an extension direction of the wire (flat cable) on the body. The connector of Patent Reference 2 is constituted in such a fashion that the connector fitting direction defined by the fitting portion of the body substantially intersects the extension direction of the wire (flat cable) on the body.

### [Patent Reference 1]

Japanese Unexamined patent Publication (Kokai) No. 2000-277190

### [Patent Reference 2]

Japanese Unexamined patent Publication (Kokai) No. 2002-25667

### DISCLOSURE OF THE INVENTION

The wire connection structure of the connector disclosed in Patent Reference 1 described above has the structure in which the conductor of the wire is sandwiched under pressure between the outer edge of the conductor-connecting section of the terminal element and the contact surface of the contact member that have mutually corresponding curve shapes due to relative movement of the terminal element and the contact member. Because the conductor of the wire is rubbed under pressure against the metal plate during the wire connecting operation, the conductor is likely to be damaged. In this connector, the connector fitting direction is substantially parallel to the wire extension direction on the body and the conductor-connecting sections are provided to the connector at the positions at which individual terminal elements are substantially arranged in the connector fitting direction. Therefore, the depth of the connector (an outer shape in the fitting direction, that is, in the wire extension direction), in particular, is likely to become great.

On the other hand, the connector disclosed in Patent Reference 2 is constituted in such a fashion that the connector fitting direction substantially intersects the wire extension direction on the body. Therefore, this connector can basically avoid the problem of the increase of the depth of the connector. However, in the structure described in Patent Reference 2, too, the conductor connecting sections are arranged at positions at which the individual terminal elements are substantially aligned in the connector fitting direction with respect to the contact sections. Therefore, the height of the connector (outer shape in a direction substantially intersecting the wire extension direction) is likely to become great. Particularly because the outer size of the connector is directly associated with a packaging space of a circuit substrate as an application object of the connector in a cable-substrate connecting connector, in particular, reduction of a diameter of a cable conductor, a smaller pitch of terminal elements and further reduction of an outer size of the connector have been required with a recent progress of a high-density packaging technology.

Incidentally, the terminal element having the conductor-connecting section of the insulation-displacement type has the merit that it is free from the necessity for pre-treatment for exposing the conductor in a predetermined length at the wire end. However, a technical limit exists on the size of the slit of the conductor-connecting section that can be formed by a press molding technology, and it has been believed difficult in the past to apply the terminal element to high-level high-density connection for which a terminal element arrangement pitch in the order of hundreds of microns has been required. Due to the recent progress of the press molding technology, however, it has now become possible to shape ultra-small slits in the order of dozens of microns that can accomplish such high-level high-density connection at the conductor connecting sections.

It is an object of the invention to provide, in a connector having an insulating-displacement type wire connecting structure, a connector that can minimize an outer size of a connector without deteriorating stability and reliability of connection between terminal elements and conductors.

It is another object of the present invention to provide a line connecting method in a connector having an insulation-displacement type wire connection structure, wherein a connection between a terminal element and an electric wire can be stably obtained.

### BRIEF DESCRIPTION OF THE DRAWINGS

FIG. 1 is a perspective view showing a connector according to an embodiment of the invention under an assembled state after connection of a wire.

FIG. 2 is an exploded perspective view of the connector shown in FIG. 1.

FIG. 3 is a sectional view taking along a line III-III of a first support member in the connector shown in FIG. 1 and showing terminal elements, too.

FIG. 4 is a sectional view taking along a line IV-IV of a second support member in the connector shown in FIG. 1 and showing a wire, too.

FIG. 5 is a perspective view of terminal elements in the connector shown in FIG. 1.

FIG. 6 is an explanatory view for explaining a wire connection procedure in the connector shown in FIG. 1 and also showing a wire arrangement state.

FIG. 7 is an explanatory view for explaining a wire connection procedure in the connector shown in FIG. 1, wherein (a) shows a body assembled state and (b) shows a body fixed state.

FIG. 8 shows the body shown in FIG. 7(b) together with terminal elements.

FIGS. 9(a) and (b) explanatory views for explaining a wire connection procedure of the connector shown in FIG. 11 and showing a connection completed state.

FIG. 10 is an exploded perspective view of a substrate connector that can be connected to the connector shown in FIG. 1.

FIG. 11 is a sectional view showing a mutual connection state between the connector shown in FIG. 1 and the substrate connector shown in FIG. 10.

FIG. 12 is a sectional view showing a connector system fabricated by connecting the connector shown in FIG. 1 and the substrate connector shown in FIG. 10.

FIG. 13 is a perspective view showing a connector according to another embodiment of the invention under an assembled state after connection of a wire.

FIG. 14 is an exploded perspective view of the connector shown in FIG. 13.

### MEANS FOR SOLVING THE PROBLEMS

To accomplish the object described above, the invention described in claim 1 provides a connector comprising a terminal element having an insulation-displacement type conductor-connecting section connectable to a conductor of an electric wire and a contact section capable of coming into conductive contact with a corresponding terminal element of a counterpart connector; and an electrical insulating body for supporting the terminal element while exposing the contact section; wherein the body includes a fitting portion capable of fitting to the counterpart connector while positioning the contact section of the terminal element with respect to the corresponding terminal element; and wherein the conductor-connecting section and the contact section of the terminal element are arranged to be aligned with each other in a direction intersecting a connector fitting direction determined by the fitting portion.

The invention of claim 2 provides a connector as defined in claim 1, wherein the body includes a wire-retaining section for locating the wire on a backside of the fitting portion as seen in the connector fitting direction, and wherein the connector fitting direction intersects an extending direction of the wire on the body, the extending direction defined by the wire-retaining portion.

The invention of claim 3 provides a connector as defined in claim 2, wherein the body includes a first support member having the fitting portion and supporting the terminal element, and a second support member having a wire retaining groove constituting the wire retaining portion and receiving the wire in the wire retaining groove; and wherein the conductor of the wire received in the wire retaining groove is connected in an insulation-displacement manner to the conductor-connecting section of the terminal element in a state where the first support member and the second support member are combined with each other.

The invention of claim 4 provides a connector as defined in claim 3, further comprising a shield member incorporated in the second support member, and wherein the shield member includes a securing portion for securing the first support member and the second support member to each other.

The invention of claim 5 provides a connector as defined in claim 4, wherein the wire is a coaxial cable, and wherein the shield member is capable of being electrically connected to a shielding of the coaxial cable supported on the second support member.

The invention of claim 6 provides a connector as defined in any one of claims 1 to 5, wherein the contact section of the terminal element has a curved shape capable of conductively contacting with the corresponding terminal element of the counterpart connector at a plurality of points simultaneously, and wherein the fitting portion of the body includes a projection surface having a profile corresponding to the curved shape of the contact section of the terminal element.

The invention of claim 7 provides a connector as defined in any one of claims 1 to 6, comprising a plurality of terminal elements disposed on the body in a mutually side-by-side arrangement, each of the terminal elements having the insulation-displacement type conductor-connecting section and the contact section, arranged to be aligned with each other in a direction intersecting the connector fitting direction.

The invention of claim 8 provides a connector as defined in claim 7, wherein the plurality of terminal elements includes a first terminal element and a second terminal element, a distance between the conductor-connecting section and the contact section of the first terminal element being different from a distance between the conductor-connecting section and the contact section of the second terminal element.

The invention of claim 9 provides a method for connecting an electric wire in a connector as defined in claim 7 or 8, comprising locating a plurality of electric wires on a backside of the fitting portion as seen in the connector fitting direction, the wires extending in a direction intersecting the connector fitting direction on the electrical insulating body; and attaching simultaneously the plurality of terminal elements under a pressing force to the body locating the wires thereon, and connecting each of the wires to the conductor connecting section of each of the terminal elements in an insulation displacing manner.

### EFFECT OF THE INVENTION

According to the invention of claim 1, the conductor-connecting sections and the contact sections of the terminal elements are aligned and arranged in the direction intersecting the connector fitting direction. Therefore, the insulation-displacement type connection structure of the conductor-connecting section of the terminal element and the conductor of the wire can be deviated and arranged by a suitable distance in the direction intersecting the connector fitting direction with respect to the fitting portion of the body and eventually, the increase of the height of the connector (outer size in the connector fitting direction) can be effectively avoided. Since this connector employs the high reliability insulation-displacement type wire connecting structure for bringing the conductor-connecting section of the terminal element into pressure contact with the conductor of the wire, the characterizing arrangement structure of the terminal elements does not at all affect the connection form between the terminal elements and the wire. Therefore, this invention can minimize the outer size of the connector (particularly the height) without deteriorating stability and reliability of connection between the terminal elements and the conductors of the wires. Incidentally, the term “intersecting the connector fitting direction” is the concept that includes “crossing at right angles” but is not limited thereto. The term “intersecting direction” is naturally a direction different from the arrangement direction of a plurality of terminal elements in the structure in which the terminal elements are aligned and arranged in parallel.

Because the invention of claim 2 has the structure in which the connector fitting direction intersects substantially at right angles the wire extension direction on the body, the increase of the depth of the connector (outer size in the wire extension direction) can be basically avoided and moreover, because the wire is arranged at the back of the fitting portion as viewed in the connector fitting direction, the increase of the depth of the connector can be effectively avoided even in the structure in which the connection structure between the conductor-connecting sections of the terminal elements and the conductors of the wires is deviated and arranged in the direction intersecting the connector fitting direction with respect to the fitting portion.

According to the invention of claim 3, the body is divided into the first support member and the second support member, and the conductors of the wire as the connection object are arranged in advance in the wire retaining grooves of the second support member to which the conductor-connecting sections of the terminal elements supported by the first support member can approach. Therefore, the wire conductors can be brought easily and correctly into pressure contact with the conductor-connecting sections of the terminal elements during the wire connecting operation.

According to the invention of claim 4, the shield member is connected to the ground potential when assembly of the connector is completed. Therefore, the shield structure for the signal transmission route in the connector can be established and high speed transfer performance of the connector can be improved. Moreover, because the shield member is provided with the function of fixing the first and second support members with each other, the number of components can be decreased.

The invention of claim 5 can establish a high-level shield structure that does not deteriorate the high speed transfer performance inherent to the coaxial cable by means of the shield member set to the equal potential to the shield layer of the coaxial cable.

When a connector system comprising the connector and the counterpart connector is constituted, the invention of claim 6 can provide a structure in which the corresponding terminal elements are electrically connected to one another at a plurality of positions. Therefore, even when the size of the terminal element is decreased so as to cope with a high-density connection structure, reliability of connection of the contacts can be improved.

According to the invention of claim 7, even in the arrangement where a plurality of terminal elements are provided, it is possible to minimize the outer size of the connector (particularly the height) without deteriorating stability and reliability of connection between the terminal elements and the conductors of the wires.

According to the invention of claim 8, it is possible to reduce the pitch of the side-by-side arrangement of the first and second terminal elements while preventing a short-circuit between the insulation-displacement type conductor-connecting sections thereof.

According to the invention of claim 9, it is possible to connect the conductor connecting sections of the terminal elements to the conductors of the electric wires previously incorporated in the body, stably under the pressing force in the insulation displacing manner.

### BEST MODE FOR CARRYING OUT THE INVENTION

Hereinafter, embodiments of the invention will be explained in detail with reference to the accompanying drawings. Common reference numerals will be allocated to corresponding constituent elements throughout all the drawings.

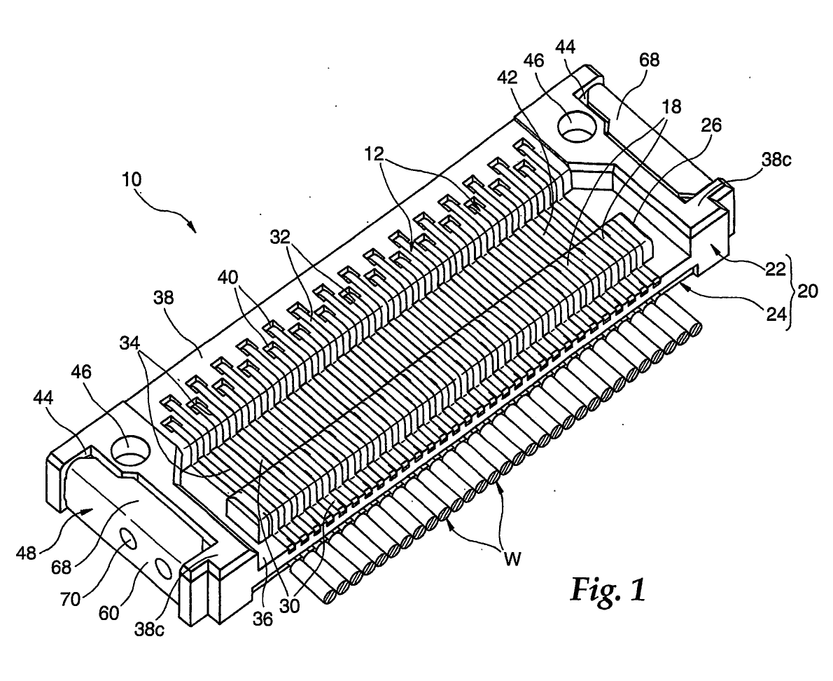

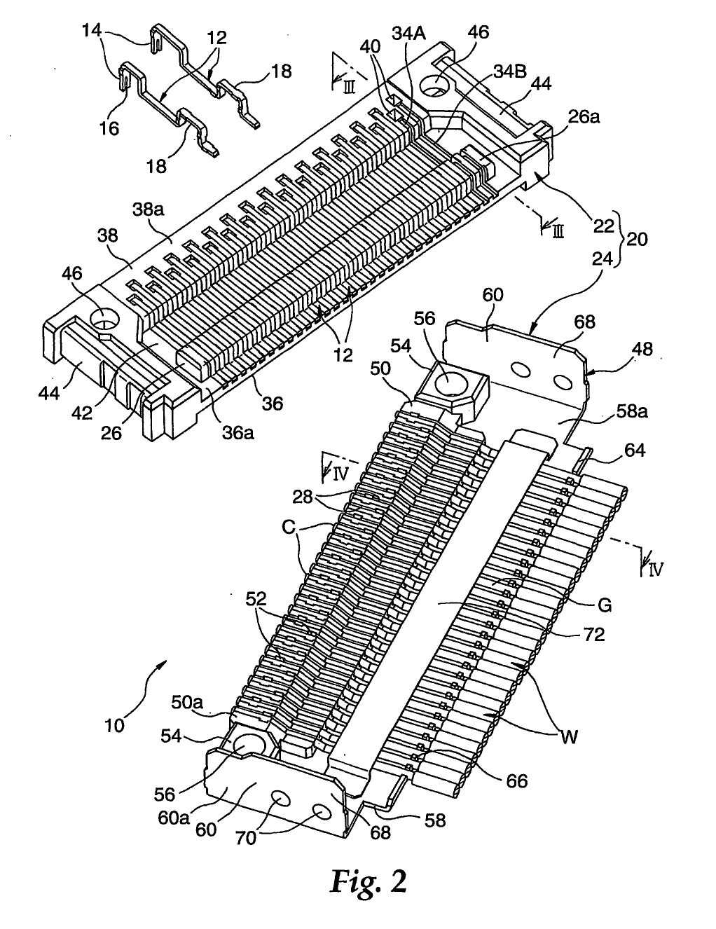

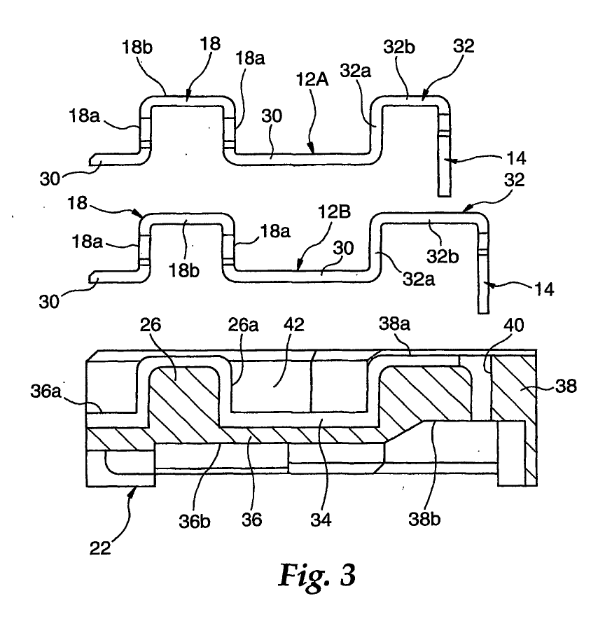

FIG. 1 is a perspective view showing a connector 10 according to an embodiment of the invention under an assembled state. FIG. 2 is an exploded perspective view of the connector 10. FIGS. 3 to 5 are drawings showing main constituent elements of the connector 10. The connector 10 has an insulation-displacement type wire connection structure in which a slit 16 having a smaller width than a conductor diameter is formed in a conductor-connecting section 14 of each terminal element 12 into a sharp outer shape. The conductor-connecting section 14 is pierced into a sheath (or an insulating layer) and the conductor C is press-fitted into the slit 16 so as to connect a wire W to the terminal element 12. The connector of the embodiment shown in the drawing can be advantageously applied particularly as a flat-cable connector for connecting a multi-core flat coaxial cable to a circuit substrate as will be explained later. In this case, another connector as a counterpart of the connector 10 (hereinafter called “counterpart connector”) can be constituted as a substrate connector packaged to the circuit substrate. However, the connector according to the invention is not limited to such an application but can be executed as various connectors for other connection applications.

The connector 10 includes a plurality of terminal elements 12 each having an insulation-displacement type conductor-connecting section 14 to be connected to a conductor C of a wire W and a contact section 18 coming into electric contact with a corresponding terminal element (not shown) of a counterpart connector and an electrically insulating body 20 for exposing the individual contact sections 18 and supporting the terminal elements 12. The body 20 includes a first support member 22 for supporting the terminal elements 12 and a second support member 24 for supporting the wire W, the first and second support members being fixedly combined with one another. A fitting portion 26 for positioning the contact sections 18 of the terminal elements 12 to the corresponding terminal elements of the counterpart connector and fits them to the counterpart connector is provided to the first support member 22. A plurality of wire retaining grooves 28 for individually accepting the wires W is formed in the second support member 24.

The terminal elements 12 of the connector 10 contain two kinds of terminal elements 12A and 12B that have substantially the same shape but partially different sizes in a longitudinal direction. In these terminals 12A and 12B, the first terminal elements 12A and the second terminal elements 12B, having mutually different sizes, are alternately arranged in parallel in a predetermined equidistant parallel arrangement, are assembled to the first support member 22 of the body 20 and are supported under the state where they are insulated from one another. Each terminal element 12A, 12B is a pin-like member formed from a metal plate having high electric conduction into a predetermined shape through a pressing process, for example, and integrally includes shank portions 30 at one of the ends and at an intermediate portion, contact sections 18 so formed between adjacent shank portions 30 as to be bent and extend between the shank portions 30 and supported while exposed on the surface of a fitting portion 26 of the first support member 22, offset portions 32 so formed as to be bent and extend from the intermediate shank portion 30 and to be spaced apart from, and oppose, the contact section 18, and a conductor-connecting section 14 at the other end extended from the offset portion 32 (see FIGS. 3 and 5).

A pair of shank portions 30 of each terminal element 12A, 12B is mutually aligned and extended on a line and the contact section 18 and the offset portion 32 are extended to positions having a mutually equal distance from the shank portions 30. The contact section 18 includes a pair of contact portions 18a bent and connected to the shank portions 30 and extended in a direction substantially intersecting the shank portions 30 and a beam portion 18b bent and connected to the contact sections 18a and extended between the contact sections 18a. Because of such a bent shape, the contact section 18 can be connected simultaneously and electrically to the corresponding terminal elements of the counterpart connector at two positions on the exposed end faces of both contact sections 18a as will be later described.

The offset portion 32 of each terminal element 12A, 12B includes a rise portion 32a extending parallel to one of the contact sections 18a of the contact section 18 in a spaced-apart relation and opposing the contact section 18a and an extension portion 32b intersecting substantially at right angles the rise portion 32a and extended in a direction away from the intermediate shank portion 30. The first and second terminal elements 12A and 12B are different only in that the size of the extension portion 32b of the offset portion 32 in the longitudinal direction is mutually different, and have substantially the same shape and the same size at other portions.

The conductor-connecting section 14 of each terminal element 12A, 12B is bent substantially at right angles and connected to the extension portion 32b of the offset portion 32 and is extended substantially parallel to the rise portion 32a. Therefore, the conductor-connecting section 14 is formed at a position at which it is spaced apart from and parallel to the contact sections 18a of the contact portion 18. The conductor-connecting section 14 is extended to a position beyond both shank portions 30 and a linear slit 16 is so formed in a predetermined length as to extend from the end of each conductor-connecting section 14 towards the extension portion 32b. Consequently, a sharp outer shape like a tuning fork is applied to each conductor-connecting section 14. Incidentally, the number of terminal elements assembled and the number of kinds are not limited in the present invention. Therefore, connectors having one kind of terminal elements, connectors having terminal elements having three or more kinds of length and connectors having only one terminal element can be employed in the invention.

The first support member 22 constituting the body 20 is integrally molded from an electrically insulating resin material by injection molding, for example, and has a plurality of terminal arranging grooves 34 for accepting and supporting the terminal elements 12A and 12B in the predetermined arrangement described above (FIGS. 1 to 3). The first support member 22 includes a flat sheet-like base portion 36 having a rectangular shape as viewed on a plane, for supporting the shank portions 30 of each terminal element 12A, 12B, a fitting portion 26 protruding to an intermediate position of one surface 36a of the base portion 36, extending in a ridge form in the longitudinal direction of the base portion and supporting the contact section 18 of each terminal element 12A, 12B, and an edge wall portion 38 protruding along the outer edge of the surface 36a of the base portion 36 in a bracket shape as viewed on a plane and supporting the offset portion 32 of each terminal 12A, 12B.

The fitting portion 26 has a protruding surface 26a having a bracket-shaped sectional shape corresponding to the bent shape of the contact section 18 of the terminal element 12. The edge wall portion 38 has a bulging surface 38a (FIG. 3) bulging to a height substantially equal to the protruding surface 26a of the fitting portion 26 in such a fashion as to correspond to the bent shape of the offset portion 32 of the terminal element 12. Each of the terminal arranging grooves 34 is bent on its bottom surface along the surface 36a of the base portion 36, the protruding surface 26a of the fitting portion 26 and the bulging surface 38a of the edge wall portion 38 and extends in the transverse direction of the base portion. The terminal arranging grooves 34 include two kinds of grooves 34A and 34B (FIG. 2) having mutually different sizes on the bulging surface 38a of the edge wall portion 38 and these different kinds of terminal arranging grooves 34A and 34B are alternately arranged in a predetermined equidistant parallel arrangement and are buried in the first support member 22.

The base portion 36 has a back surface 36b expanding substantially flat on the opposite side to the surface 36a. The edge wall portion 38 has a back surface 38b expanding from the back surface 36b of the base portion 36 towards the surface side 36a on the opposite side to the bulging surface 38a. Each terminal arranging groove 34A, 34B is communicated to a plurality of guide holes 40 penetrating between the bulging surface 38a and the back surface 38b at the end on the bulging surface 38a of the edge wall portion 38. These guide holes 40 are arranged zigzag as viewed on the plane on the bulging surface 38a of the edge wall portion 38.

Recesses 42 for accepting a part of the counterpart connector are formed on both sides of the fitting portion 26 as viewed in the transverse sectional direction of the first support member 22 among the fitting portion 26 of the first support member 22, the base portion 36 and the edge wall portion 38. Engagement grooves 44 for fixing the second support member 24 are formed in the outer surface of the edge wall portion 38 at both ends of the first support member 22 in its longitudinal direction (FIGS. 1 and 2). Further, a positioning wall 46 penetrating between the bulging surface 38a of the edge wall portion 38 and the back surface 38b is formed in the proximity of each engagement groove 44.

Each of the terminal elements 12A, 12B is accepted by the terminal arranging groove 34A, 34B having a corresponding size while its conductor-connecting section 14 is inserted into each guide hole 40 of the first support member 22. When each terminal element 12A, 12B is accepted appropriately by the corresponding terminal arranging groove 34A, 34B, the conductor-connecting section 14 of each terminal element 12A, 12B is arranged in such a fashion that the slit 16 extends outward from the back surface 38b of the edge wall portion 38, and the contact section 18 of each terminal element 12A, 12B is fixedly arranged along the protruding surface 26a of the fitting portion 26. Incidentally, to fix the terminal element 12 into the terminal arranging groove 34, a known anchor edge having a local concavo-convexity shape may be formed at a suitable position of the terminal element 12.

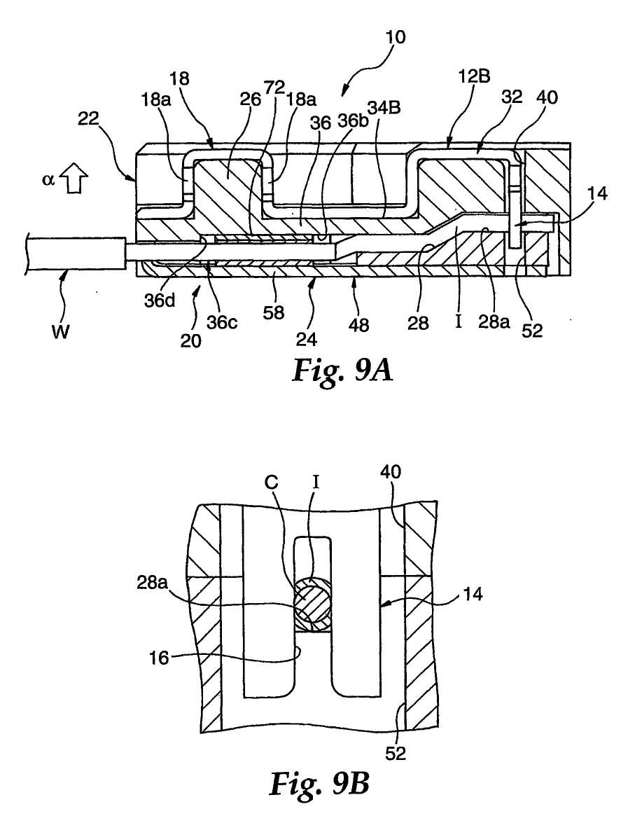

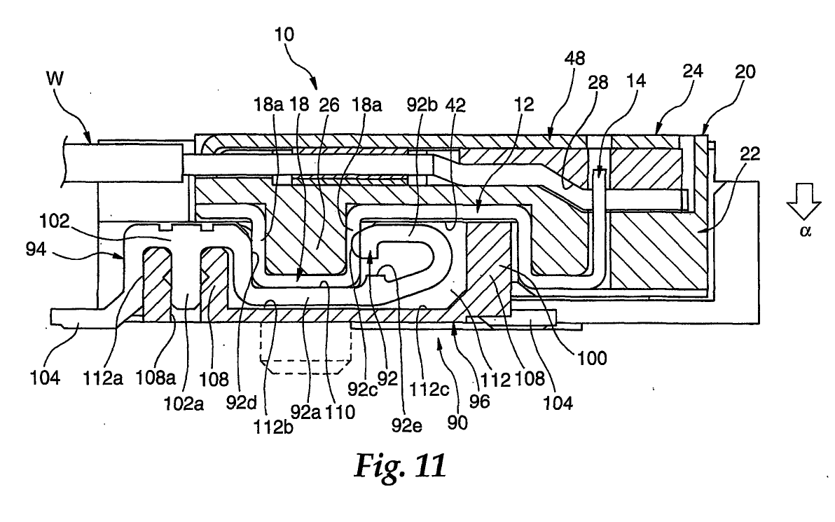

Here, the contact sections 18 of the terminal elements 12A and 12B arranged and supported on the protruding surface 26a of the fitting portion 26 operate as a swelling male type contact section having a pair of contact sections 18a and is complementarily fitted to a female type contact section (not shown) of the corresponding terminal element of the counterpart connector accepted in the recess 42 of the first support member 22 to thereby establish electric connection. Therefore, the fitting direction of the connector 10 defined by the fitting portion 26 of the body 20 (that is, the moving direction (indicated by an arrow a in FIGS. 9 and 11) of the connector 10 for appropriately fitting the fitting portion 26 into the complementary fitting portion of the counterpart connector) is coincident with the extension direction of the contact section 18a of the contact section 18 of each terminal element 12 (that is, the direction intersecting substantially at right angles the shank portion 30 of each terminal element 12). As a result, the conductor-connecting sections 14 of the individual terminal elements 12A and 12B and the contact sections 18 are aligned and arranged in the direction intersecting substantially at right angles the connector fitting direction defined by the fitting portion 26.

The second support member 24 of the body 20 is integrally molded from an electrically insulating resin material by an injection molding process, for example, while assembling therein a later-appearing shield member 48 at a predetermined position. The second support member 24 includes a sheet-like base portion 50 having a substantially rectangular shape as viewed on a plane and a plurality of wire retaining grooves 28 on one of its surface 50a, and a pair of positioning portions 54 so formed as to protrude from both ends of the base portion 50 in the longitudinal direction. Incidentally, it is also possible to employ a construction in which a shield member having a suitable shape is assembled to the second support member molded in advance into a suitable shape in place of the construction shown in the drawing in which the shield member 48 is insert-molded into the second support member 24.

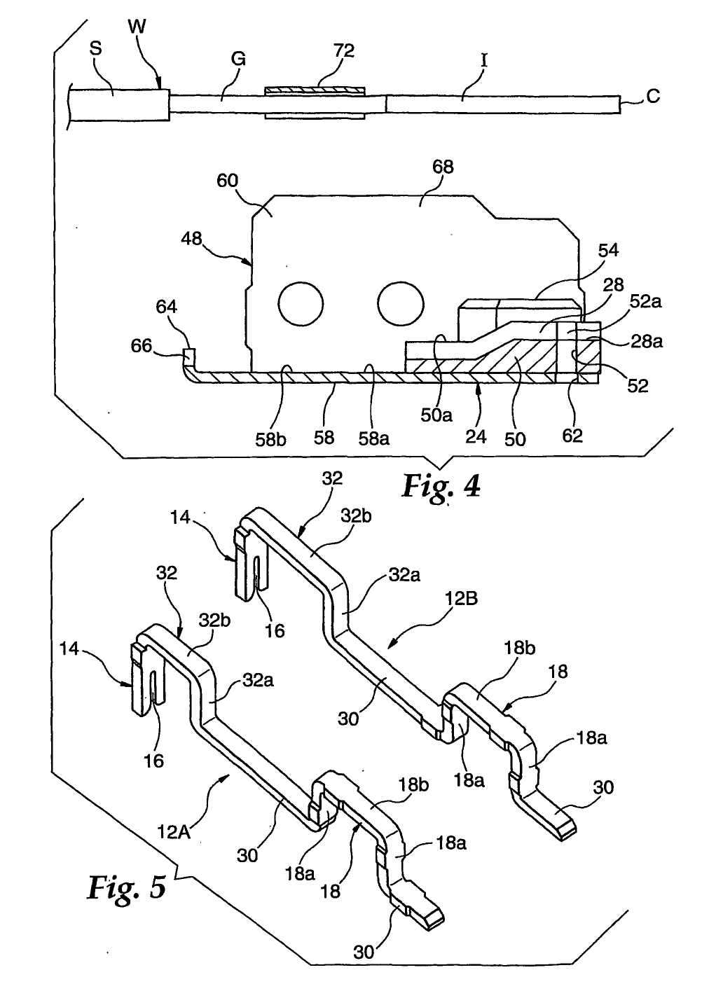

The wire retaining grooves 28 of the base portion 50 are defined in the surface 50a while arranged in a predetermined equidistant arrangement in the longitudinal direction of the base portion. The region of the base portion 50 positioned on the outer edge side of the second support member 24 when viewed in its transverse sectional direction is relatively thick, so that the bottom surface of each wire retaining groove 28 is bent in a crank shape along the surface 50a of the base portion and extends in the transverse sectional direction of the base portion. Wire acceptance surfaces 28a are formed on the bottom surfaces of the wire retaining groove 28 along the thick region of the base portion 50. Bores 52 locally opening to these wire acceptance surfaces 28a and individually accepting the conductor-connecting sections 14 of the terminal elements 12 supported by the first support member 22 are so formed as to penetrate through the base portion 50 in the direction of its thickness. Each bore 52 has a width a little greater than the width of the wire retaining groove 28 and notches 52a as the extension portion of the bore 52 are locally formed on both sidewalls of the wire retaining groove 28 (FIG. 4). The bores 52 are arranged zigzag on the surface 50a of the base portion as viewed on the plane (FIG. 2).

The wire retaining grooves 28 have a shape and a size capable of accepting stably and individually a plurality of wires W as the connection object of the connector 10, particularly the portions from which the sheath S is removed to expose the conductor insulator I. The bores 52 have a size and a shape capable of individually accepting the conductor-connecting sections 14 of the terminal elements 12 supported by the first support member 22. Each wire retaining groove 28 operates as a wire retaining portion for arranging the wire W at the back of the fitting portion 26 of the first support member 22 when viewed in the connector fitting direction as will be later described.

A pair of positioning portions 54 is formed as extension portions thicker than the thick region of the base portion 50 at both ends of the base portion 50 in the longitudinal direction. Each positioning portion 54 has a positioning hole 56 penetrating through the positioning portion 54 in the direction of thickness. When the first and second support members 22 and 24 are combined appropriately as will be later described, the back surface 38b of the edge wall portion 38 of the first support member 22 is placed while keeping contact with the surface 50a of the base portion 50 of the second support member 24, a plurality of guide holes 40 of the first support member are respectively arranged in registration with the bores 52 of the second support member 24, and the pair of the positioning holes 46 of the first support member 22 are respectively arranged in registration with the positioning holes 56 of the positioning portions 54 of the second support member 24. Under this state, the shield member 48 is arranged in such a fashion that its entire part is substantially exposed outside from the body 20.

The shield member 48 is a thin sheet member that is shaped into a predetermined shape from a sheet metal material having high electric conduction through a press process, for example, and includes a substrate portion 58 assembled integrally into the base portion 50 of the second support member 24 and having a rectangular shape when viewed on the plane, and a pair of end plate portions 50 bent and extended towards the surface 58a side at both ends of the substrate portion 58 in its longitudinal direction (FIGS. 2 and 4). The base portion 50 is fixedly disposed on the surface 58a while its thick region extends along one of the side edges extending in the longitudinal direction of the substrate portion 58. A plurality of openings 62 penetrating in the thickness direction is formed at positions corresponding to the positions of the bores 52 of the base portion 50.

The substrate portion 58 of the shield member 48 extends outward from the thin region of the base portion 50 and its surface 58a is exposed. The substrate portion 58 has a slight rise portion 64 at the other side edge spaced apart from the base portion 50 in the longitudinal direction. A plurality of recesses 66 arranged on the extension of the wire retaining grooves 28 of the base portion 50 are formed in the rise portion 64. A later-appearing bonding region 58b is disposed between the base portion 50 and the rise portion 64 on the exposed surface 58a of the substrate portion 58 (FIG. 4).

A pair of end plate portions 60 of the shield member 48 is accepted by the engagement grooves 44 disposed at both ends of the first support member 22 in the longitudinal direction when the first support member 22 and the second support member 24 are appropriately combined. A fixing portion 68 for fixing the second support member 24 to the first support member 22 is disposed in a terminal region of each end plate portion 60 away from the substrate portion 58. After the first and second support members 22 and 24 are combined, the fixing portions 68 of these end plate portions 60 are bent in such a fashion as to embrace the edge wall portions 38 at both ends of the first support member 22 in the longitudinal direction and are accepted by the engage grooves 44. Under this state, the first support member 22 and the second support member 34 are fixed with each other (FIG. 1). Incidentally, a pair of engagement recesses 70 is locally formed on the outer surface 60a of each end plate portion 60 (FIG. 2).

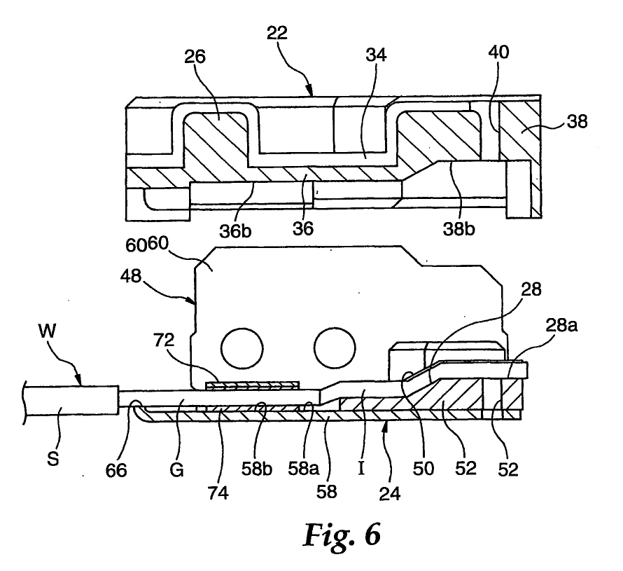

The wire connecting procedure of the connector 10 having the construction described above and its assembly steps will be explained about an application example to a multi-core flat coaxial cable with reference to FIGS. 6 to 9.

As a preparatory operation, the sheath S and the shield layer G inside the sheath S are removed step-wise in a predetermined length at an end of a multi-core flat wire (coaxial cable) W to expose a conductor insulator I encompassing conductors C. After this pre-treatment, a plurality of wires W are individually inserted into a plurality of wire retaining grooves 28 defined in the base portion 50 of the second support member 24 before it is assembled to the first support member 22, and the exposed portion of the conductor insulator I of each wire W is arranged along the wire acceptance surface 28a of the corresponding wire retaining groove 28. At this time, the shield layer G exposed portion of each wire W is taken out from the corresponding wire retaining groove 28, is arranged along the bonding region 58b of the shield member 48 assembled into the second support member 24 and is accepted by the corresponding recess 66 of the rise portion 64 of the shield member 48 (FIG. 6).

A grounding plate 72 (FIGS. 2 and 4) formed of a thin metal sheet having high electric conduction and a shape corresponding to the exposed surface of the bonding region 58b is prepared, is uniformly fixed to the shield layers G of all the wires W through, for example, a crimping member (not shown) or a solder 74, and is crimped or soldered to the bonding region 58b of the shield member 48 (FIG. 6). Consequently, the wires W are fixedly held by the corresponding wire retaining grooves 28 of the second support member 24 in the terminal regions of the wires W and the shield layers G of these wires W are electrically connected to the common shield member 48. Incidentally, the grounding plate 72 may be fixed provisionally by an adhesive to the shield layer G of the flat wires W. The portion of the wire W at which the conductor insulator I is exposed is processed into an excessive length beyond the wire retaining groove 28 when it is inserted into the wire retaining groove 28, and the excessive length portion of each wire W may be cut off after joining of the grounding plate 72.

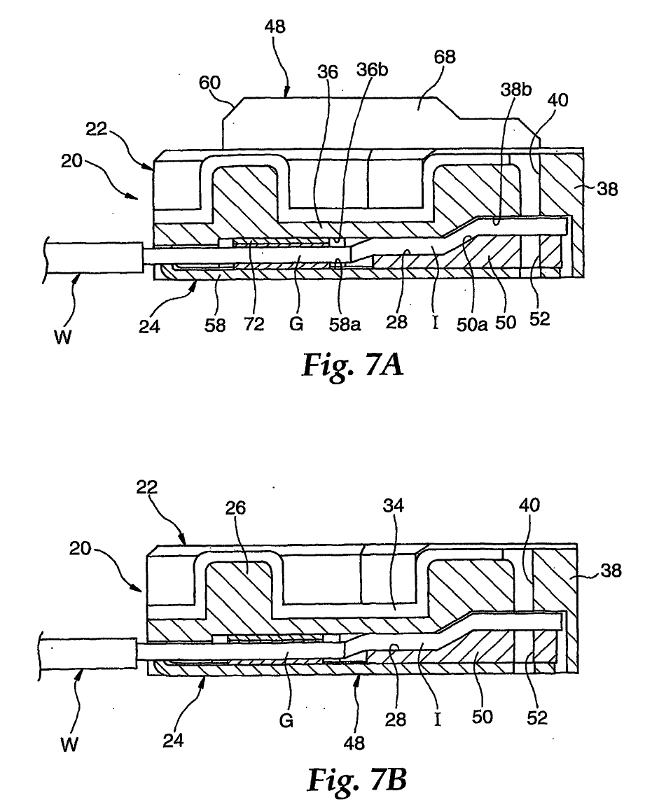

After the wires W are fixed to and supported by the second support member 24 in the manner described above, the back surface 36b of the base portion 36 and the back surface 38b of the edge wall portion 38 of the first support member 22 are so arranged as to respectively oppose the substrate portion surface 58a of the shield member 48 and the surface 50a of the base portion 50 of the second support member 24 and the end plate portions 60 of the shield member 48 of the second support member 24 are inserted into the engagement grooves 44 at the ends of the first support member 22 in the longitudinal direction. The first and second support members 22 and 24 are thus combined at the appropriate position and form the body 20 (FIG. 7(a)). At this time, positioning jigs, not shown, are fitted into the pair of positioning holes 56 of the second support member 24 and the support members 22 and 24 can thus be arrange mutually, easily and correctly.

The fixing portions 68 provided to the end plate portions 60 of the shield member 48 of the second support member 24 are bent at this appropriate position along the engagement grooves 44 of the first support member 22 as described above and are anchored to the edge wall portions 38, thereby fixing the first and second support members 22 and 24 with one another (FIG. 7(b)). The guide holes 40 of the first support member 22 are arranged under this state at positions respectively coincident with the bores 52 of the second support member 24. In consequence, the portion of the wire W accepted in each wire retaining groove 28, at which the conductor insulator I is exposed, extends between the guide hole 40 and the bore 52 inside the wire retaining groove 28. Under the suitable combination state of the body 20, the wires W are arranged along the back surface 36b of the base portion 36 of the first support member 22 and particularly the portion of the wire W exposing the shield layer G is arranged at the back of the fitting portion 26 in the connector fitting direction described above.

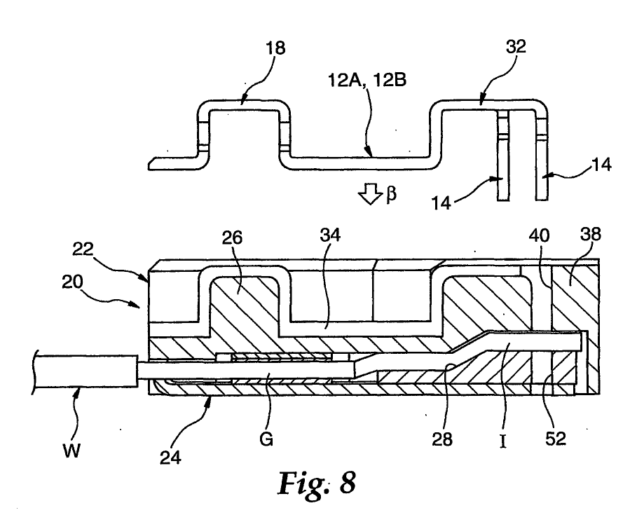

The terminals 12A and 12B are fitted into the corresponding terminal arranging grooves 34A and 34D (FIG. 2) while the respective conductor-connecting sections 14 are inserted into the guide holes 40 of the first support member 22 by the push force acting in a direction indicated by an arrow β in FIG. 8 with respect to the body 20 fixedly retaining the wires W between the first and second support members 22 and 24. With this inserting operation, the conductor-connecting section 14 of each terminal element 12A, 12B protrudes from the guide hole 40 and pierces the conductor insulator I of the wire W arranged adjacent to this guide hole 40. At this time, the wire acceptance surface 28a of the wire retaining groove 28 receives the push force acting from the conductor-connecting section 14 of the terminal element 12 to the conductor insulator I of the wire W and makes it possible to conduct stable piercing.

At the point at which each terminal element 12 is completely fitted into the terminal arranging groove 34, the distal end of the conductor-connecting section 14 of the terminal element 12 is accepted by the bore 52 of the second support member 24 and the conductor C of the wire W is press-fitted into the slit 16 (FIG. 9(b)). The wires W are stably connected in this way in the insulation-displacement system to the corresponding terminal elements 12 and assembly of the connector 10 is completed. Incidentally, it is advantageous in this insulation-displacement operation to efficiently apply the push force to the terminal elements 12 by use of insulation-displacement jigs, not shown, and to fit the terminal elements 12A, 12B either discretely or as a bulk into the terminal arranging grooves 34A, 34B.

Under the state where assembly of the connector 10 is finished, the connector fitting direction α of each terminal 12 and the contact section 18 defined by the fitting portion 26 of the body 20 is coincident with the extension direction of the contact section 18a of the contact section 18 of each terminal element 12 already described (FIG. 9(a)). In the resulting connector 10, therefore, the conductor-connecting section 14 of each terminal element 12 and the contact section 18 are aligned and arranged parallel to each other in the direction intersecting substantially at right angles the connector fitting direction α. The connector fitting direction α in the connector 10 intersects substantially at right angles the extension direction of the wires W on the body 20.

In the above finished condition, when external force, such as tensile force, is applied to the wires W, the grounding plate 72 joined to the shield member 48 can receive such external force, so that the connecting areas between the conductor-connecting sections 14 of respective terminal elements 12 and wires W are substantially free of the external force. Also, the grounding plate 72 is held in a space 36c defined between the substrate portion 58 of the shield member 48 of the second support member 24 and the base portion 36 of the first support member 22 and is prevented from being displaced from the space 36c by a shoulder 36d formed on the back surface 36b of the base portion 36 (FIG. 9(a)), so that it is possible to stably maintain a proper wire-connecting condition against the external force, such as tensile force, applied to the wires W.

Because the conductor-connecting section 14 of each terminal element 12 and the contact section 18 are aligned and arranged parallel to each other in the direction intersecting substantially at right angles the connector fitting direction α in the connector 10 as described above, the insulation-displacement type connection structure between the conductor-connection section 14 of the terminal element 12 and the conductor C of the wire W can be suitably deviated in the direction intersecting substantially at right angles the connector fitting direction α with respect to the fitting portion 26 of the body 20. As a result, in comparison with the structure of Patent Reference 2 in which the conductor-connecting sections and the contact sections of the individual terminal elements are aligned in the connector fitting direction, the increase of the height of the connector 10 (outer dimension in the connector fitting direction α) can be effectively avoided. Since the connector 10 employs the high-reliability insulation-displacement type connection structure for press-fitting the conductor-connecting sections 14 of the terminal elements 12 to the conductors C of the wires W, the characterizing arrangement structure of the terminal elements 12 described above does not at all affect the connection form between the terminal elements 12 and the wires W. Therefore, this connector 10 can minimize the outer size (particularly the height) of the connector 10 without deteriorating stability and reliability of connection between the terminal elements 12 and the wire conductors C.

Moreover, since the connector 10 has a structure in which the connector fitting direction α intersects substantially at right angles the extension direction of the wires W on the body 20, this connector 10 can basically avoid the increase of its depth (the outer size in the wire extension direction) in comparison with the structure of Patent Reference 1 in which the connector fitting direction is substantially parallel to the wire extension direction. Particularly because the wires W are arranged at the back of the fitting portion 26 in the connector fitting direction α in this connector 10, increase of the depth of the connector 10 can be effectively avoided even when the connection structure between the conductor-connecting sections 14 of the terminal elements 12 and the conductors C of the wires W is deviated in the wire extension direction with respect to the fitting portion 26 of the body 20 as already described.

When assembly of the connector 10 is completed, the shield member 48 assembled into the second support member 24 is extended on the major part of the outer surface of the body 20. Therefore, when the shield member 48 electrically connected to the shield layers G of the individual wires W are connected to the ground potential of the counterpart connector, for example, a shield structure of a high level can be established for a signal transfer route in a connector system comprising the connector 10 and the counterpart connector, and high-speed transfer performance of this connector system can be improved.

Since the connector 10 having the construction described above uses the insulation-displacement type wire connection structure having excellent stability and high reliability, it can accomplish a high-density connection structure capable of coping with a smaller diameter of the conductors of the wires and a smaller pitch of the arrangement of the terminal elements 12. To arrange the insulation-displacement type conductor-connecting sections 14 of the terminal elements 12 in such a smaller pitch to cope with high-density connection, this connector 10 uses two kinds of terminal elements 12A and 12B having different lengths of offset portions 32 and arranges zigzag the conductor-connecting sections 14 of the terminals 12. As a result, in the high-density connection structure that can be accomplished in this connector 10, an outer diameter of the wire conductor C is not greater than 0.09 mm (AWG (American Wire Grade) 40 or more) and the arrangement pitch of the terminal elements 12 is 0.3 mm or below. The conductor-connecting section 14 of the terminal element 12 that can be applied to high-density connection of this level (particularly, slit 16) can be produced by the existing press molding technology. Furthermore, the outer size of the connector 10 that can be accomplished has a depth of 3 to 5 mm and a height of 1 to 2 mm, for example.

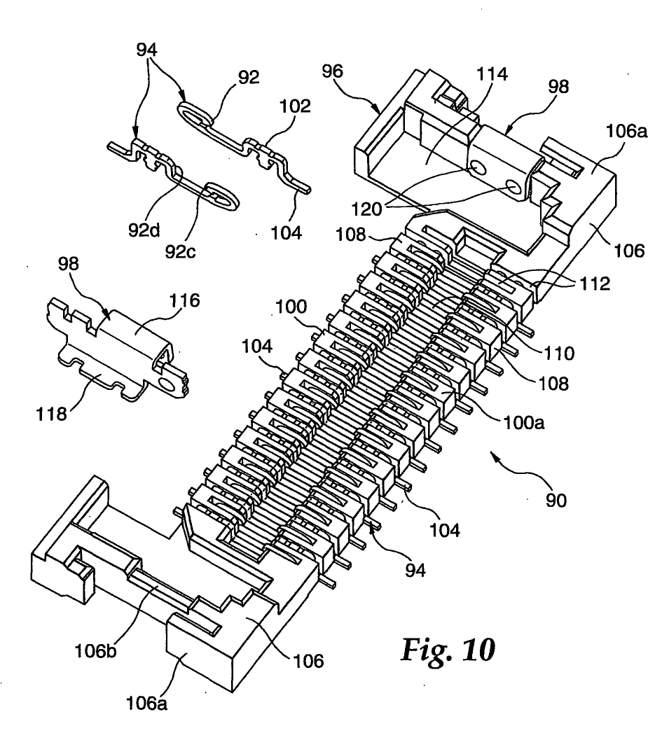

FIG. 10 shows a substrate connector 90 constituted as the counterpart connector of the connector 10. The substrate connector 90 includes a plurality of terminal elements 94 each having a female type contact portion 92 coming into electric contact with the male type contact section 18 of each terminal element 12 provided to the connector 10, an electrically insulating body 96 for exposing the individual contact sections 92 and supporting their terminals 94, and a pair of grounding members 98 supported by the body 96 while insulated from the terminals 94 and electrically connected to the shield member 48 provided to the connector 10. The body 96 has a female type fitting portion 100 for individually positioning the contact sections 92 of the terminal elements 94 to the corresponding terminal elements 12 of the connector 10 and complementarily fitting them into the fitting portions 26 of the body 20 of the connector 10.

The terminal elements 94 of the substrate connector 90 all have the same shape and the same size and are aligned on and supported by the fitting portion 100 of the body 96 in parallel with one another in a predetermined equidistant arrangement. Each terminal element 94 is a pin-like member shaped from a metal sheet having high electric conduction into a predetermined shape through a press process, for example, and integrally includes a fitting portion 102 at an intermediate position press-fitted into the fitting portion 100 of the body 96, a contact portion 92 at one of the ends that is extended from the fitting portion 102 and is exposed on the surface of the fitting portion 100 and a lead portion 104 at the other end that is extended from the fitting portion 102 on the opposite side to the contact section 92 and protrudes outside the body 96. The fitting portion 102 of the terminal element 94 has a substantially M-shaped outer shape having a press-fit plate 102a at its center (FIG. 11).

The contact section 92 of each terminal element 94 includes a beam portion 92a extended straight from one of the ends of the fitting portion 102 and a resilient arm portion 92b connected to the end of the beam portion 92a and extended in a substantial V-shape in a direction intersecting the beam portion 92a (FIG. 11). The contact section 92 is supported by the fitting portion 102 in a cantilever arrangement and the resilient arm portion 92b, in particular, can undergo flexible deflection relative to the beam portion 92a upon receiving the external force. The resilient arm portion 92b of the contact section 92 has a contact 92c at its end. A second contact 92d as one of the constituent elements of the contact section 92 is formed on one of the legs of the fitting portion 102 adjacent to the contact section 92 at a position opposing the contact 92c of the resilient arm portion 92b. A pair of contacts 92c and 92d of the contact section 92 constitutes a first contact 92d arranged substantially fixedly on the fitting portion 100 and a second contact 92c so arranged as to be capable of undergoing flexible displacement while opposing the first contact 92d in the spaced-apart relation. Under the load-free state where the resilient arm portion 92b does not undergo flexible deformation, these contacts 92c and 92d are spaced apart from each other by a distance slightly smaller than the distance between the exposed end faces of the pair of contact sections 18a in the contact section 18 of the terminal element 12 of the connector 10.

A lead portion 104 of the terminal 94 is linearly extended from the other end of the fitting portion 102 and slightly extends beyond the beam portion 92a of the contact section 92. The lead portion 104 protrudes from the body 96 and can be connected to a conductor pad formed on a circuit substrate, not shown, for packaging the substrate connector 90.

The body 96 is integrally molded from an electrically insulating resin material by an injection molding process, for example, and includes a fitting portion 100 having a substantially rectangular shape as viewed on a plane, for supporting the terminal elements 94 and a pair of acceptance portions 106 formed at both ends of the fitting portion 100 in the axial direction. The fitting portion 100 has a pair of protuberance portions 108 extending in the longitudinal direction and a recess 110 for complementarily accepting the fitting portion 26 of the connector 10 is formed between the protuberance portions 108. The fitting portion 100 further has a plurality of grooves 112 for individually accepting the terminal elements 94 on one of the surfaces 100a thereof. These grooves 112 are aligned equidistantly in such a fashion as to correspond to the equidistant arrangement of the terminals 12 of the connector 10 and are extended in the transverse sectional direction of the fitting portion while bridging the protuberance portions 108 and the recesses 110. Each groove 112 has a shape of a slit that is open at one of the ends but is closed at the other end as viewed in the transverse sectional direction of the fitting portion 100 and the adjacent grooves 112 are open at mutually different ends.

Each groove 112 has a shape and a size such that it fixedly accepts the fitting portion 102 of the terminal element 102 in its region 112a extending along the protuberance portion 108 of the fitting portion 100 on the side opening at the end, also accepts fixedly the beam portion 92a of the contact section 92 of the terminal element 94 in its region 112b extending along the recess 110 of the fitting portion 100, and accepts the resilient arm portion 92b of the contact section 92 of the terminal element 94 in its region 112c extending along the protuberance portion 108 of the fitting portion 100 on the side at which the slit of the groove 112 is not opened, in such a fashion as to allow rocking of the resilient arm portion 92b (FIG. 11). A hole 108a for tightly accepting the press-fit plate 102a of the fitting portion 102 of the terminal element 94 is formed inside the protuberance portion 108 on the side opening at the end. Therefore, the terminal elements 94 are arranged in the fitting portion 100 in the parallel arrangement in which the contact sections 92 alternately oppose one another so that the second contact 92c of one of the terminal elements 94 and the first contact 92d of the other terminal element 94 are aligned between the adjacent terminal elements 94.

Owing to the characterizing feature of the contact section 92, each terminal element 94 fitted to the fitting portion 100 can acquire a required contact pressure under flexible displacement of the second contact 92c although the spatial distance is small between the beam portion 92a and the second contact 92c and eventually contributes to the reduction of the height of the substrate connector 90 (outer size as viewed in the fitting direction x of the counterpart connector 10). Owing to the alternate arrangement of the terminal elements 94 in the substrate connector 90, the lead portions 104 of these terminal elements 94 protrude alternately in the mutually opposite directions from the fitting portion 100 and are arranged zigzag outside the body 96. The zigzag arrangement of the terminal lead portions 104 makes it possible to accomplish the narrower pitch of the arrangement of the terminal elements 94 in such a fashion as to correspond to the high-density connection structure of the connector 10 described above.

Each terminal element 94 is arranged so that the pair of contacts 92c and 92d of the contact section can protrude into the recesses 110 of the fitting portion 100 under the state where the terminal element 94 is appropriately fitted into the groove 112 of the fitting portion 100 of the body 96. Therefore, when the fitting portion 26 of the connector 10 is fitted into the recess 110 of the substrate connector 90, the contact section 18 of the corresponding terminal element 12 of the connector 10 is inserted between the contacts 92c and 92d of the terminal element 94 and undergoes flexible deflection in such a fashion that the resilient arm portion 92b can be expanded outward. Under this state, the contacts 92c and 92d of the terminal 94 simultaneously come into contact with the exposed end face of the contact sections 18a of the terminal element 12 at a required contact pressure and establish electric conduction (FIG. 1). The contact system comprising the connectors 10 and 90 has the structure in which the corresponding terminal elements 12 and 94 come into mutual contact and establish electric conduction and can therefore improve reliability of contact and conduction of the contacts even when the terminal elements 12 and 94 are miniaturized so as to correspond to the high-density connection structure described above.

When the fitting portion 26 of the connector 10 is fitted into the recess 110 of the substrate connector 90, a certain length around the contact 92c of the terminal element 94 is liable to bend in a direction toward the beam portion 92a due to a pressure from the contact section 18 of the terminal element 12. In order to prevent such excessive bending in the resilient arm portion 92b, a seat 92e projecting opposite to the contact 92c is formed in a boundary area between the beam portion 92a and the resilient arm portion 92b on the terminal element 94 (FIG. 11).

Each of the acceptance portions 106 of the body 96 has the recess 114 for complementarily accepting the longitudinal end portion 38c (FIG. 1) of the edge wall portion 38 of the first support member 22 that constitutes the body 20 of the connector 10. A fitting groove 106b for fitting the grounding member 98 is formed at a predetermined position of the longitudinal end wall 106a defining the recess 114 in each acceptance portion 106.

Each grounding member 98 is a thin sheet member molded from a metal sheet material having high electric conduction through a press process, for example, and includes a substrate portion 116 having a U-shaped section and fitted into the fitting groove 106b of the acceptance portion 106 of the body 96 and a terminal portion 118 so shaped as to expand outward from one of the edges of the substrate portion 116 while intersecting substantially at right angles the surface of the substrate portion 116. The grounding member 98 is fitted into the fitting groove 106b in such a fashion that its terminal portion 118 protrudes outward from the end wall 106a of the acceptance portion 106 of the body 96. A pair of protuberances 120 is locally formed at predetermined positions of the surface on the end wall 106a of the acceptance portion 106 on the side of the recess 114.

Due to the characterizing shape and arrangement of the terminal elements 94, the substrate connector 90 having the construction described above can reduce the outer size so as to cope with high-density packaging of the circuit substrate as already described. The substrate connector 90 and the connector are connected while keeping the mutually appropriate positional relationship when the fitting portions 26 of the latter are complementarily fitted into the recesses 110 of the fitting portions 100 of the former and the edge walls 38 of the latter are complementarily fitted into the recesses 114 of the acceptance portions 106 of the former. Under this appropriate connection state, the mutually corresponding terminal elements 12 and 9 are connected while keeping two-point contact at the respective contact portions 18 and 92 having the structurally male-female relation. Moreover, because the contact portions 92 of the terminal elements 94 on the female side are alternately arranged in the mutually opposite directions, flexible righting moment occurring in the respective resilient arm portions 92b during two-point contact is balanced direction-wise as a whole and acts from the second contacts 92c on the counterpart terminals 12 (that is, the fitting portion 26). In addition to complementary fitting between the fitting portions 26 and 100 and complementary fitting between the edge wall portions 38 and the acceptance portions 106, the protuberance portions 108 of the fitting portion 100 of the substrate connector 90 are complementarily fitted into the recesses 42 of the first support member 22 of the connector 10. Therefore, even when the external force resulting from pulling and distortion of the wires W acts on the connector 10, for example, the connection-conduction state between the corresponding terminal elements 12 and 94, that is, the appropriate connection state between the connectors 10 and 90, can be maintained stably irrespective of the direction of the external force.

Under the appropriate connection state described above, the shield member 48 assembled into the second support member 24 of the connector 10 is electrically connected to the pair of grounding members 98 while the pair of engagement recesses 70 provided to each end plate portion 60 accepts the pair of protuberances 120 provided to each grounding member 98. Mutual fitting between the engagement recesses 70 of the shield member 48 and the protuberances 120 of the grounding member 98 operates as a latch structure for keeping the appropriate connection state between the connector 10 and the substrate connector 90. When the grounding members 98 of the substrate connector 90 are connected at their terminal portions 118 to the grounding conductor of the circuit substrate, not shown, for packaging the substrate connector 90, the ground potential is applied to the shield member 48 of the connector 10. As a result, the shield structure of the high level can be established for the signal transfer route of the connector system including the connector 10 and the substrate connector 90 and the high-speed transfer performance of this connector system can be improved.

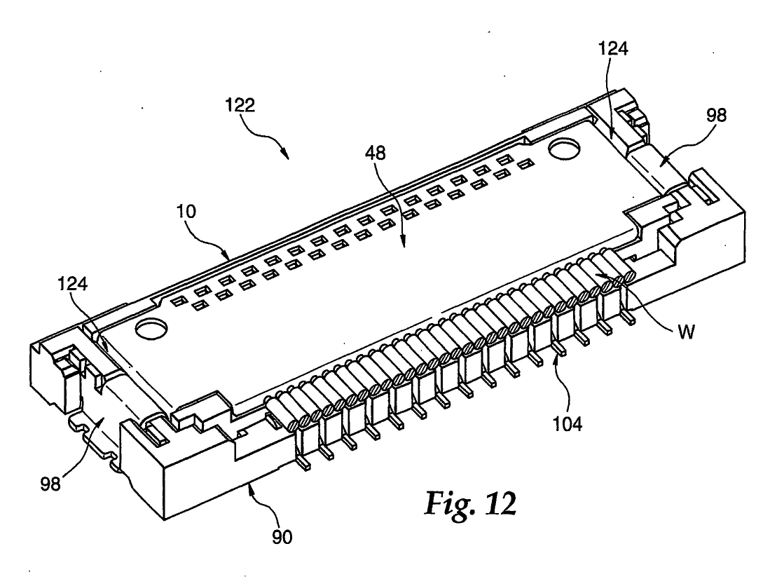

FIG. 12 shows a connector system 122 fabricated by appropriately connecting the connector 10 and the substrate connector 90. In this connector system 122, the overall outer size can be effectively reduced in addition to the reduction of the outer sizes of the connectors 10 and 90 described above. As a result, the packaging space of the circuit substrate as the application object of the connector system 122 can be effectively secured so as to cope with the high-density packaging technology. Moreover, owing to the characterizing mutual fitting structure of the connectors 10 and 90 described above, the connector system 122 can stably keep the appropriate connection state of the connectors 10 and 90. It should be noted that, in order to detach the connectors 10, 90 from each other, a suitable tool (not shown) may be inserted into a gap 124 defined in the longitudinal opposite end areas of the connectors 10, 90 and then be handled for detachment.

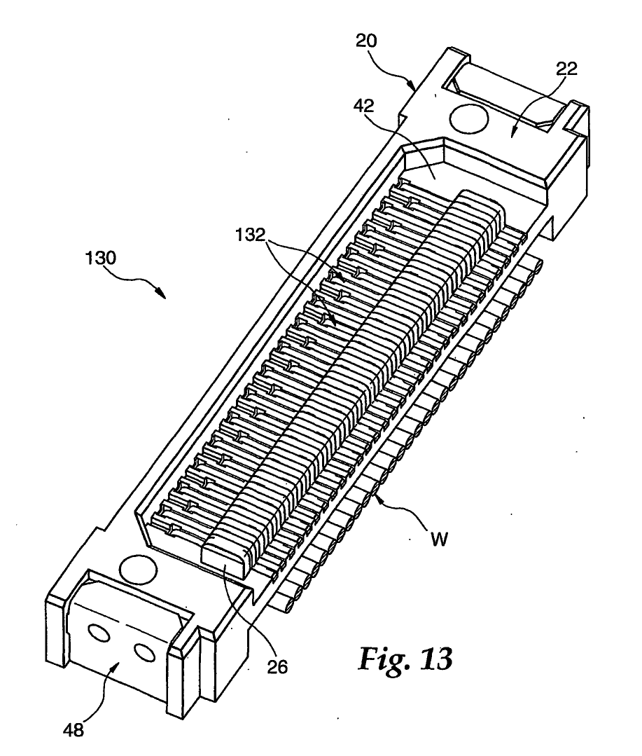

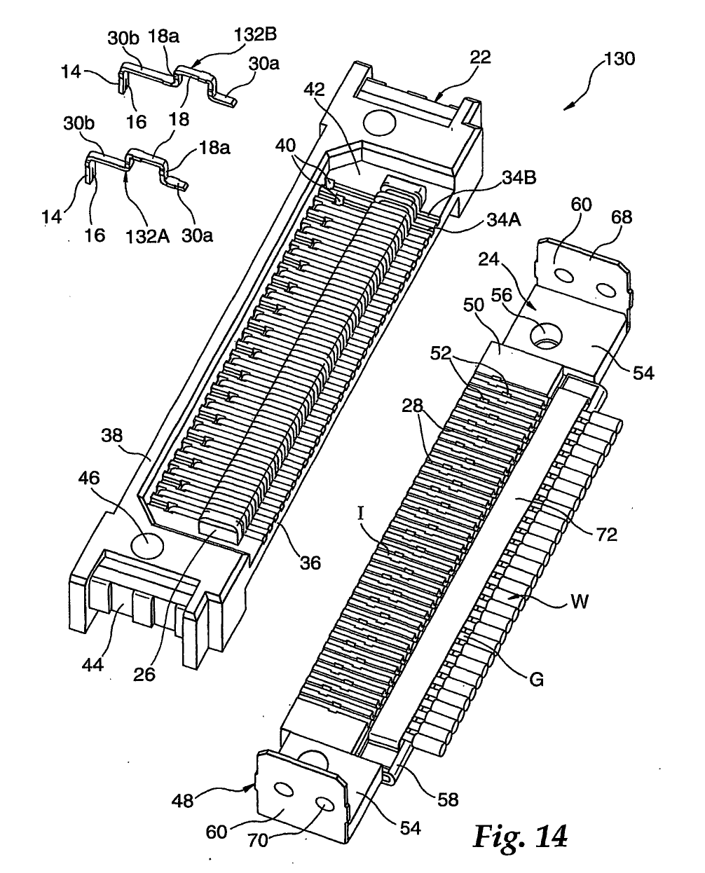

FIGS. 13 and 14 show a connector 130 according to still another embodiment of the invention. This connector 130 further reduces particularly the depth (outer shape in the wire extension direction) of the connector by using terminal elements 132 having a smaller size in the longitudinal direction than the terminal elements 12 of the connector 10 described above. The rest of the constructions of the connector 130 are substantially the same as those of the connector 10. Therefore, common reference numerals will be allocated to corresponding constituent elements and their explanation will be omitted.

A plurality of terminal elements 132 of the connector 130 includes two kinds of terminals 132A and 132B having substantially the same shape but mutually different sizes in the longitudinal direction. These terminals 132A and 132B have a predetermined equidistant parallel arrangement in which the terminal elements 132A and 132B having the mutually different sizes are alternately arranged in parallel, are assembled to the first support member 22 of the body 20 and are supported under the mutually insulated state. Each terminal element 132A, 13213 is a pin-like member molded into a predetermined shape from a metal sheet having high conduction through a press process, for example, and includes integrally the shank portion 30a at one of the ends, an intermediate shank portion 30b, a contact section 18 bent and extended between these shank portions 30a and 30b and supported while exposed on the surface of the fitting portion 26 of the first support member 22 and a conductor-connecting section 14 at the other end bent on the opposite side to the contact section 18 and extended from the intermediate shank portion 30b. In other words, each terminal element 132A, 132B does not have the offset portion 32 in the terminal elements 12A and 12B of the connector 10 described already and has a smaller overall length as much.

The shank portions 30a and 30b of each terminal element 132A, 132B are arranged and extended in a line. Different kinds of terminals 132A and 132B are different only in the longitudinal length of the intermediate shank portion 30b and have substantially the same shape and size with each other at other portions. The conductor-connecting sections 14 of each terminal element 132A, 132B are extended in a direction substantially parallel to the contact section 18a of the contact section 18 on the opposite side to the contact section 18 while interposing the shank portion 30b, and a linear slit 16 is formed from the end of each conductor-connecting section 14 in a predetermined length towards the shank portion 30b.

A plurality of terminal arranging grooves 34A and 34B are formed in the first support member 22 constituting the body 20 of the connector 130 along the base portion 36 and the fitting portion 26 but the edge wall portion 38 is not formed so as to correspond to the terminals 132A and 132B having such a construction. In other words, a plurality of guide holes 40 is formed in a zigzag arrangement between the fitting portion 26 and the edge wall portion 38 inside the recesses 42 of the base portion in order to accept the conductor-connecting sections 14 of the terminals 132A and 132B. These guide holes 40 are arranged zigzag as viewed on a plane on the protuberance surface 38a of the edge wall portion 38a. Owing to such a construction, the depth of the first support member 22 is reduced.

The size of the second support member 24 constituting the body 20 of the connector 130 in the transverse sectional direction of the substrate portion 58 of the shield member 48 is decreased in such a manner as to correspond to the first support member 22. Consequently, the depth of the second support member 24 is decreased. The depth of the connector 130 is thus decreased as a whole. It will be understood that the connector 130 having such a construction can provide the action and effect equivalent to that of the connector 10 described already.

### INDUSTRIAL APPLICABILITY

The invention provides the connector having the wire connection structure for bringing the conductors of the wires into insulation-displacement type connection with the conductor-connecting sections of the terminal elements that can be used particularly effectively in the field in which the outer size of the connector must be reduced as much as possible.

1. A connector comprising:
a terminal element having an insulation-displacement type conductor-connecting section connectable to a conductor of an electric wire and a contact section capable of coming into conductive contact with a corresponding terminal element of a counterpart connector; and
an electrical insulating body for supporting said terminal element while exposing said contact section;
wherein said body includes a fitting portion capable of fitting to the counterpart connector while positioning said contact section of said terminal element with respect to the corresponding terminal element; and
wherein said conductor-connecting section and said contact section of said terminal element are arranged to be aligned with each other in a direction intersecting a connector fitting direction determined by said fitting portion.

2. A connector as defined in claim 1, wherein said body includes a wire-retaining section for locating the wire on a backside of said fitting portion as seen in said connector fitting direction, and wherein said connector fitting direction intersects an extending direction of the wire on said body, said extending direction defined by said wire-retaining portion.

3. A connector as defined in claim 2, wherein said body includes a first support member having said fitting portion and supporting said terminal element, and a second support member having a wire retaining groove constituting said wire retaining portion and receiving the wire in said wire retaining groove; and wherein said conductor of said wire received in said wire retaining groove is connected in an insulation-displacement manner to said conductor-connecting section of said terminal element in a state where said first support member and said second support member are combined with each other.

4. A connector as defined in claim 3, further comprising a shield member incorporated in said second support member, and wherein said shield member includes a securing portion for securing said first support member and said second support member to each other.

5. A connector as defined in to claim 4, wherein the wire is a coaxial cable, and wherein said shield member is capable of being electrically connected to a shielding of the coaxial cable supported on said second support member.

6. A connector as defined in claim 1, wherein said contact section of said terminal element has a curved shape capable of conductively contacting with the corresponding terminal element of the counterpart connector at a plurality of points simultaneously, and wherein said fitting portion of said body includes a projection surface having a profile corresponding to the curved shape of said contact section of said terminal element.

7. A connector as defined in claim 1, comprising a plurality of terminal elements disposed on said body in a mutually side-by-side arrangement, each of said terminal elements having said insulation-displacement type conductor-connecting section and said contact section, arranged to be aligned with each other in a direction intersecting said connector fitting direction.

8. A connector as defined in claim 7, wherein said plurality of terminal elements includes a first terminal element and a second terminal element, a distance between said conductor-connecting section and said contact section of said first terminal element being different from a distance between said conductor-connecting section and said contact section of said second terminal element.

9. A method for connecting an electric wire in a connector as defined in claim 7, comprising:
locating a plurality of electric wires on a backside of said fitting portion as seen in said connector fitting direction, said wires extending in a direction intersecting said connector fitting direction on said electrical insulating body; and
attaching simultaneously said plurality of terminal elements under a pressing force to said body locating said wires thereon, and connecting each of said wires to said conductor connecting section of each of said terminal elements in an insulation displacing manner.
